(19) United States
(12) Patent Application Publication
(10) Pub. No.: US 2024/0339260 A1
(43) Pub. Date: Oct. 10, 2024

(54) TRANSFORMER AND TRANSFORMER SYSTEM

(71) Applicant: Delta Electronics, Inc., Taoyuan City (TW)

(72) Inventors: Yu-Chen Hsieh, Taoyuan City (TW); Chieh-Tung Lu, Taoyuan City (TW); Sheng-Heng Chung, Taoyuan City (TW); Li-O Lee, Taoyuan City (TW); Chi-Kai Lin, Taoyuan City (TW); Chin-Hsin Lai, Taoyuan City (TW)

(21) Appl. No.: 18/427,588

(22) Filed: Jan. 30, 2024

(30) Foreign Application Priority Data
Apr. 7, 2023 (CN) 202320756760.X

(51) Int. Cl. H01F 27/29; H01F 27/24; H01F 27/30

(52) U.S. Cl. CPC H01F 27/292; H01F 27/24; H01F 27/306

(57) ABSTRACT

A transformer includes a magnetic core and four windings. The magnetic core includes a first flange, a second flange and a middle core part. The first terminal of the first winding, the third terminal of the second winding, the fifth terminal of the third winding and the seventh terminal of the fourth winding are disposed on the first flange. The second terminal of the first winding, the fourth terminal of the second winding, the sixth terminal of the third winding and the eighth terminal of the fourth winding are disposed on the second flange. The first winding and the second winding are twisted with each other to dispose around the middle core part. The third winding and the fourth winding are twisted with each other to dispose around the middle core part, or the third winding and the fourth winding are disposed around the middle core part in parallel.

### CROSS-REFERENCE TO RELATED APPLICATION

This application claims priority to China Patent Application No. 202320756760.X filed on Apr. 7, 2023, the entire contents of which are incorporated herein by reference for all purposes.

### FIELD OF THE INVENTION

The present disclosure relates to a transformer and a transformer system, and more particularly to a transformer and a transformer system including a plurality of windings.

### BACKGROUND OF THE INVENTION

Generally, the transformer includes a plurality of windings, such as primary winding and secondary winding. The plurality of windings are directly wound around the magnetic core and arranged in parallel. Under this circumstance, the windings of the transformer are relatively loose to decrease the coupling between the primary winding and the secondary winding. Consequently, the frequency upper limit value of the transformer is decreased. Namely, the bandwidth of the transformer is decreased. In addition, there is a resonance point existed in the operating frequency range of the transformer when the turns of winding of the transformer are increased. For example, the resonance point is existed between 1 MHz and 500 MHz of the frequency. The power spectral density (PDS) of the transformer is increased by the resonance point. Consequently, the noise of the transformer easily exceeds the upper limit value of the test data, which makes the noise of the transformer to be measured easily. The signal-to-noise ratio of the transformer is increased. Moreover, the windings of the transformer are relatively loose to decrease the attenuation excluding the operating frequency range of the transformer. For example, the attenuation excluding the operating frequency range of the transformer is lower than 3 dB. Consequently, the frequency waveform of the transformer produces jitters easily so as to effect the measuring result of the transformer. The characteristic of the transformer is worse.

Therefore, there is a need of providing a transformer and a transformer system to obviate the drawbacks encountered from the prior arts.

### SUMMARY OF THE INVENTION

The present disclosure provides a transformer and a transformer system. The first winding and the second winding of the transformer are twisted with each other to dispose around the middle core part. The third winding and the fourth winding are twisted with each other to dispose around the middle core part, or the third winding and the fourth winding are disposed around the middle core part in parallel. The windings of the transformer are disposed around the middle core part tightly. According to the above winding structure, the frequency upper limit value of the transformer is enhanced. Namely, the bandwidth of the transformer is enhanced. Moreover, the transformer of the present disclosure has no resonance point. The attenuation of the transformer can reach 14 dB, which is greater than the attenuation of the conventional transformer. The frequency waveform of the transformer is less prone to jitter in the high frequency so as to enhance the characteristic of the transformer. The power spectral density of the transformer is decreased to under the upper limit value. Consequently, the noise of the transformer of the present disclosure is not easy to be measured so that the signal-to-noise ratio of the transformer is decreased.

In accordance with an aspect of the present disclosure, there is provided a transformer. The transformer includes a magnetic core, a first winding, a second winding, a third winding and a fourth winding. The magnetic core includes a first flange, a second flange and a middle core part. The middle core part is located between the first flange and the second flange. The first winding includes a first terminal and a second terminal. The first terminal is disposed on the first flange. The second terminal is disposed on the second flange. The first winding is disposed around the middle core part. The second winding includes a third terminal and a fourth terminal. The third terminal is disposed on the first flange. The fourth terminal is disposed on the second flange. The second winding is disposed around the middle core part. The third winding includes a fifth terminal and a sixth terminal. The fifth terminal is disposed on the first flange. The sixth terminal is disposed on the second flange. The third winding is disposed around the middle core part. The fourth winding includes a seventh terminal and an eighth terminal. The seventh terminal is disposed on the first flange. The eighth terminal is disposed on the second flange. The fourth winding is disposed around the middle core part. The first winding and the second winding are twisted with each other to form a first twist winding. The first twist winding is disposed around the middle core part. The third winding and the fourth winding are twisted with each other to form a second twist winding. The second twist winding is disposed around the middle core part. The first twist winding and the second twist winding are not twisted with each other.

In accordance with another aspect of the present disclosure, there is provided a transformer. The transformer includes a magnetic core, a first winding, a second winding, a third winding and a fourth winding. The magnetic core includes a first flange, a second flange and a middle core part. The middle core part is located between the first flange and the second flange. The first winding includes a first terminal and a second terminal. The first terminal is disposed on the first flange. The second terminal is disposed on the second flange. The first winding is disposed around the middle core part. The second winding includes a third terminal and a fourth terminal. The third terminal is disposed on the first flange. The fourth terminal is disposed on the second flange. The second winding is disposed around the middle core part. The third winding includes a fifth terminal and a sixth terminal. The fifth terminal is disposed on the first flange. The sixth terminal is disposed on the second flange. The third winding is disposed around the middle core part. The fourth winding includes a seventh terminal and an eighth terminal. The seventh terminal is disposed on the first flange. The eighth terminal is disposed on the second flange. The fourth winding is disposed around the middle core part. The first winding and the second winding are twisted with each other to dispose around the middle core part. The third winding and the fourth winding are disposed around the middle core part in parallel.

In accordance with another aspect of the present disclosure, there is provided a transformer system. The transformer system includes a transformer and a circuit board. The transformer includes a magnetic core, a first winding, a second winding, a third winding and a fourth winding. The magnetic core includes a first flange, a second flange and a middle core part. The middle core part is located between the first flange and the second flange. The first winding includes a first terminal and a second terminal. The first terminal is disposed on the first flange. The second terminal is disposed on the second flange. The first winding is disposed around the middle core part. The second winding includes a third terminal and a fourth terminal. The third terminal is disposed on the first flange. The fourth terminal is disposed on the second flange. The second winding is disposed around the middle core part. The third winding includes a fifth terminal and a sixth terminal. The fifth terminal is disposed on the first flange. The sixth terminal is disposed on the second flange. The third winding is disposed around the middle core part. The fourth winding includes a seventh terminal and an eighth terminal. The seventh terminal is disposed on the first flange. The eighth terminal is disposed on the second flange. The fourth winding is disposed around the middle core part. The first winding and the second winding are twisted with each other to form a first twist winding. The first twist winding is disposed around the middle core part. The third winding and the fourth winding are twisted with each other to form a second twist winding. The second twist winding is disposed around the middle core part. The first twist winding and the second twist winding are not twisted with each other. The transformer is disposed on the circuit board. The circuit board has a wire. Two ends of the wire are electrically connected with the first winding and the third winding.

In accordance with another aspect of the present disclosure, there is provided a transformer system. The transformer system includes a transformer and a circuit board. The transformer includes a magnetic core, a first winding, a second winding, a third winding and a fourth winding. The magnetic core includes a first flange, a second flange and a middle core part. The middle core part is located between the first flange and the second flange. The first winding includes a first terminal and a second terminal. The first terminal is disposed on the first flange. The second terminal is disposed on the second flange. The first winding is disposed around the middle core part. The second winding includes a third terminal and a fourth terminal. The third terminal is disposed on the first flange. The fourth terminal is disposed on the second flange. The second winding is disposed around the middle core part. The third winding includes a fifth terminal and a sixth terminal. The fifth terminal is disposed on the first flange. The sixth terminal is disposed on the second flange. The third winding is disposed around the middle core part. The fourth winding includes a seventh terminal and an eighth terminal. The seventh terminal is disposed on the first flange. The eighth terminal is disposed on the second flange. The fourth winding is disposed around the middle core part. The first winding and the second winding are twisted with each other to dispose around the middle core part. The third winding and the fourth winding are disposed around the middle core part in parallel. The transformer is disposed on the circuit board. The circuit board has a wire. Two ends of the wire are electrically connected with the first winding and the third winding.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a transformer according to a first embodiment of the present disclosure;

FIG. 2 is a schematic view illustrating portion of the windings of the transformer as shown in FIG. 1;

FIG. 3 is a cross sectional view illustrating the transformer as shown in FIG. 1;

FIG. 4 and FIG. 5 are waveform diagrams illustrating the frequency and the decibel of the transformer of the present disclosure and the conventional transformer;

FIG. 6A and FIG. 6B are waveform diagrams illustrating the frequency and the decibel of the conventional transformer and the transformer of the present disclosure in high frequency;

FIG. 7A and FIG. 7B are waveform diagrams illustrating the power spectral density of the transformer of the present disclosure and the conventional transformer;

FIG. 8 is a schematic view illustrating portion of the windings of a transformer according to a second embodiment of the present disclosure;

FIG. 9 is a schematic view illustrating portion of the windings of a transformer according to a third embodiment of the present disclosure;

FIG. 10 is a schematic view illustrating portion of the windings of a transformer according to a fourth embodiment of the present disclosure;

FIG. 11 is a schematic view illustrating portion of the windings of a transformer according to a fifth embodiment of the present disclosure;

FIG. 12 is a schematic view illustrating a transformer system according to a first embodiment of the present disclosure; and

FIG. 13 is a schematic view illustrating a transformer system according to a second embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this invention are presented herein for purpose of illustration and description only. It is not intended to be exhaustive or to be limit value to the precise form disclosed.

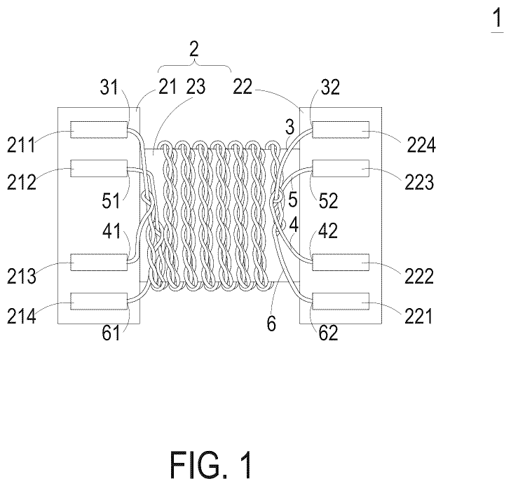

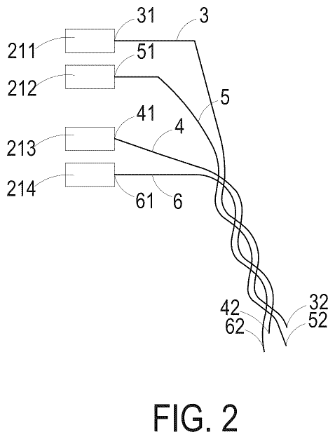

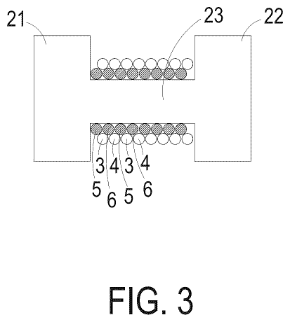

FIG. 1 is a schematic view illustrating a transformer according to a first embodiment of the present disclosure. FIG. 2 is a schematic view illustrating portion of the windings of the transformer as shown in FIG. 1. FIG. 3 is a cross sectional view illustrating the transformer as shown in FIG. 1. As shown in FIG. 1, the transformer 1 of the present disclosure includes a magnetic core 2, a first winding 3, a second winding 4, a third winding 5 and a fourth winding 6. The magnetic core 2 includes a first flange 21, a second flange 22 and a middle core part 23. The first flange 21, the second flange 22 and the middle core part 23 are integrally formed into one piece. The middle core part 23 is located and connected between the first flange 21 and the second flange 22. The first flange 21 includes a first electrode 211, a second electrode 212, a third electrode 213 and a fourth electrode 214. The first electrode 211, the second electrode 212, the third electrode 213 and the fourth electrode 214 are arranged in sequence. Namely, the first electrode 211 and the fourth electrode 214 are served as outer electrodes. The second electrode 212 and the third electrode 213 are located between the first electrode 211 and the fourth electrode 214, so that the second electrode 212 and the third electrode 213 are served as inner electrodes.

The second flange 22 includes a fifth electrode 221, a sixth electrode 222, a seventh electrode 223 and an eighth electrode 224. The fifth electrode 221, the sixth electrode 222, the seventh electrode 223 and the eighth electrode 224 are arranged in sequence. Namely, the fifth electrode 221 and the eighth electrode 224 are served as outer electrodes. The sixth electrode 222 and the seventh electrode 223 are located between the fifth electrode 221 and the eighth electrode 224, so that the sixth electrode 222 and the seventh electrode 223 are served as inner electrodes. The fifth electrode 221 located on the second flange 22 and the fourth electrode 214 located on the first flange 21 are aligned to each other. The sixth electrode 222 located on the second flange 22 and the third electrode 213 located on the first flange 21 are aligned to each other. The seventh electrode 223 located on the second flange 22 and the second electrode 212 located on the first flange 21 are aligned to each other. The eighth electrode 224 located on the second flange 22 and the first electrode 211 located on the first flange 21 are aligned to each other.

For simplifying the figure, the four electrodes located on the first flange 21 and portion of each winding are shown in FIG. 2, but the four electrodes located on the second flange are not shown in FIG. 2. As shown in FIGS. 1 and 2, the first winding 3 includes a first terminal 31 and a second terminal 32. The first terminal 31 of the first winding 3 is disposed on the first electrode 211 of the first flange 21. The second terminal 32 of the first winding 3 is disposed on the eighth electrode 224 of the second flange 22. The first winding 3 is disposed around the middle core part 23. The second winding 4 includes a third terminal 41 and a fourth terminal 42. The third terminal 41 of the second winding 4 is disposed on the third electrode 213 of the first flange 21. The fourth terminal 42 of the second winding 4 is disposed on the sixth electrode 222 of the second flange 22. The second winding 4 is disposed around the middle core part 23. The first winding 3 and the third winding 5 are served as a primary winding of the transformer 1. The third winding 5 includes a fifth terminal 51 and a sixth terminal 52. The fifth terminal 51 of the third winding 5 is disposed on the second electrode 212 of the first flange 21. The sixth terminal 52 of the third winding 5 is disposed on the seventh electrode 223 of the second flange 22. The third winding 5 is disposed around the middle core part 23. The second winding 4 and the fourth winding 6 are served as a secondary winding of the transformer 1. The fourth winding 6 includes a seventh terminal 61 and an eighth terminal 62. The seventh terminal 61 of the fourth winding 6 is disposed on the fourth electrode 214 of the first flange 21. The eighth terminal 62 of the fourth winding 6 is disposed on the fifth electrode 221 of the second flange 22. The fourth winding 6 is disposed around the middle core part 23.

According to the connection relationship of the windings, the first terminal 31 of the first winding 3, the fifth terminal 51 of the third winding 5, the third terminal 41 of the second winding 4 and the seventh terminal 6 of the fourth winding 6 of the transformer 1 are arranged in sequence and located on the first flange 21. The second terminal 32 of the first winding 3, the sixth terminal 52 of the third winding 5, the fourth terminal 42 of the second winding 4 and the eighth terminal 62 of the fourth winding 6 are arranged in sequence and located on the second flange 22. In this embodiment, the first winding 3 and the second winding 4 are twisted with each other to form a first twist winding. The first twist winding is disposed around the middle core part 23 to form an outer layer. The third winding 5 and the fourth winding 6 are twisted with each other to form a second twist winding. The second twist winding is disposed around the middle core part 23 to form an inner layer. As shown in FIG. 3, the inner layer formed by the third winding 5 and the fourth winding 6 is located between the middle core part 23 and the outer layer formed by the first winding 3 and the second winding 4. In this embodiment, the winding direction of the first winding 3 and the second winding 4 disposed around the middle core part 23 is the same with the winding direction of the third winding 5 and the fourth winding 6 disposed around the middle core part 23. Preferably, the first twist winding and the second twist winding are not twisted with each other. Consequently, the attenuation d2 of the transformer 1 of the present disclosure is decreased efficiently, so that the frequency waveform of the transformer 1 is less prone to jitter in the high frequency.

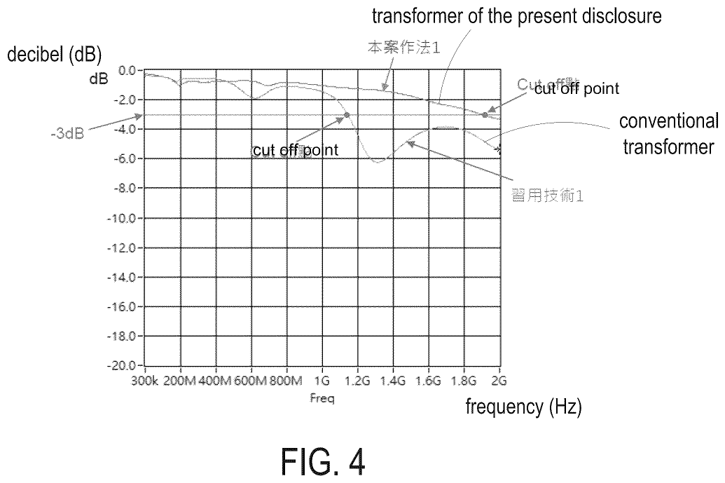

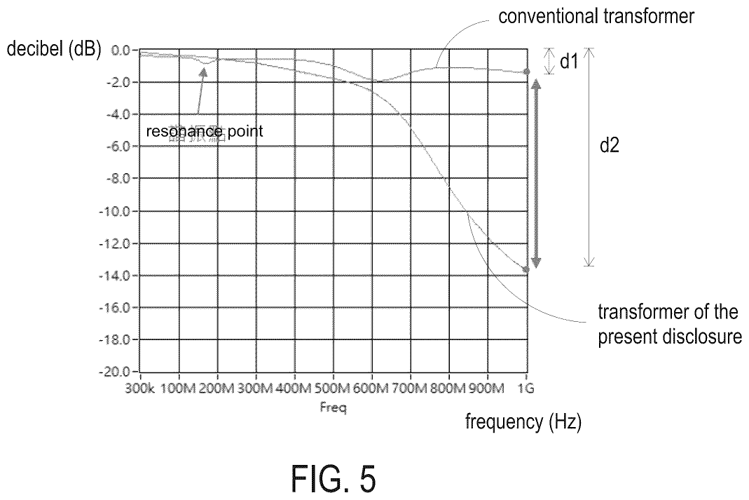

FIG. 4 and FIG. 5 are waveform diagrams illustrating the frequency and the decibel of the transformer of the present disclosure and the conventional transformer. As shown in FIG. 4, the frequency of the cutoff point corresponding to a setting decibel of the conventional transformer is 1.15 GHz. For example, the setting decibel is-3 dB. The frequency of the cutoff point corresponding to the setting decibel of the transformer 1 of the present disclosure is 1.9 GHZ. Meanwhile, the frequency of the cutoff point of the transformer is corresponding to a frequency upper limit value of the transformer. As shown in FIG. 4, the frequency upper limit value of the transformer 1 of the present disclosure is greater than the frequency upper limit value of the conventional transformer. Moreover, the bandwidth of the transformer is approximately twice the frequency upper limit value. Namely, the bandwidth of the transformer 1 of the present disclosure is greater than the bandwidth of the conventional transformer. In an embodiment, the bandwidth of the transformer 1 of the present disclosure is at least 1.3 times greater than the bandwidth of the conventional transformer.

As shown in FIG. 5, the conventional transformer has a resonance point when the frequency is 180 MHz, and the attenuation d1 of the conventional transformer is less than 2 dB. The transformer 1 of the present disclosure has no resonance point according to the winding method of the above windings, so that the attenuation d2 of the transformer 1 of the present disclosure can reach 14 dB, which is greater than the attenuation d1 of the conventional transformer. Namely, the difference between the attenuation d2 of the transformer 1 of the present disclosure and the attenuation d1 of the conventional transformer is greater than 12 dB. According to the above attenuation analysis, the attenuation d1 of the conventional transformer is greater than the attenuation d2 of the transformer 1 of the present disclosure. Consequently, the frequency waveform of the conventional transformer produces jitters in high frequency easily, and the frequency waveform of the transformer 1 of the present disclosure is less prone to jitter in high frequency.

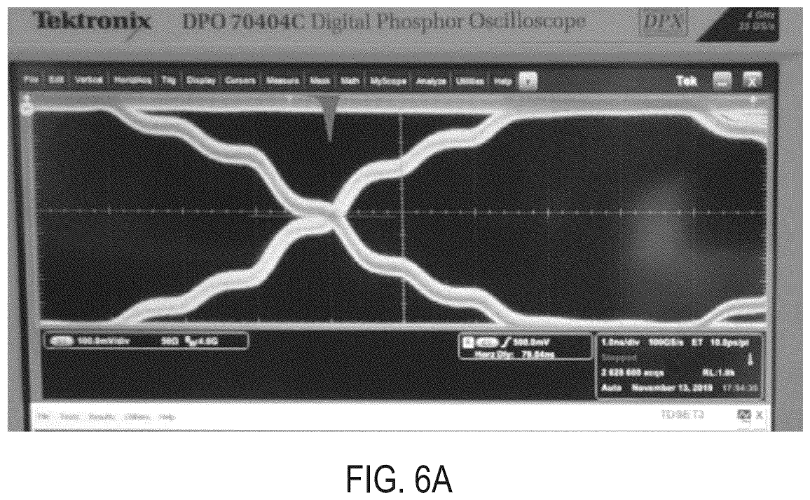

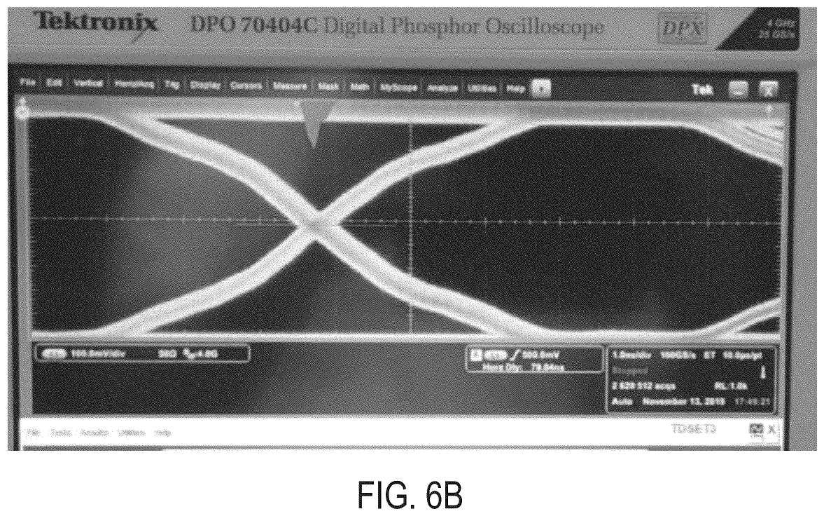

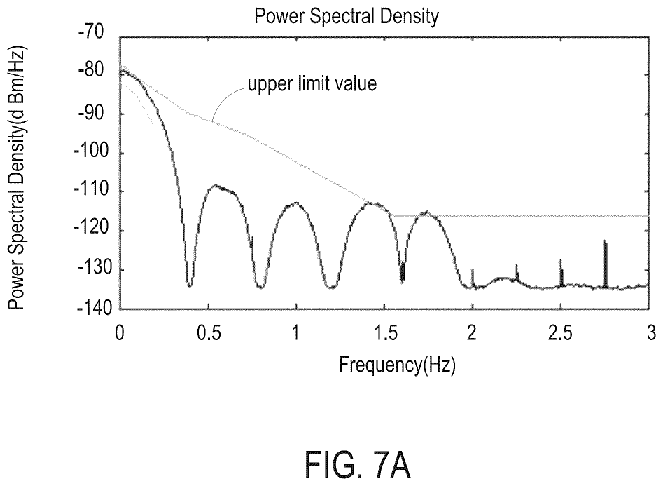

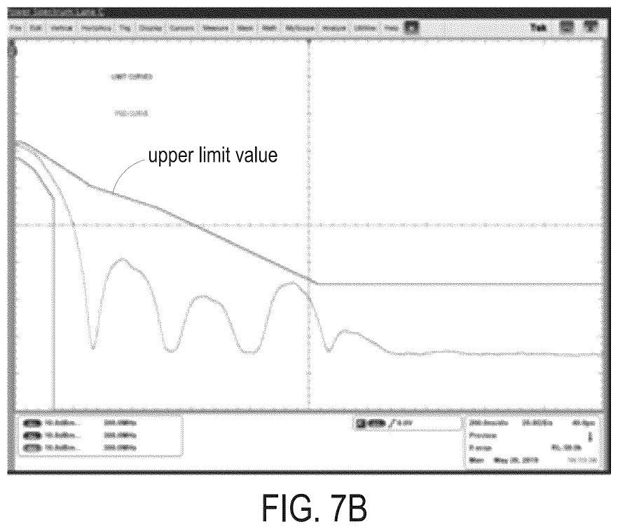

FIG. 6A and FIG. 6B are waveform diagrams illustrating the frequency and the decibel of the conventional transformer and the transformer of the present disclosure in high frequency. As shown in FIG. 6A, the frequency waveform of the conventional transformer produces jitters in high frequency. As shown in FIG. 6B, the frequency waveform of the transformer 1 of the present disclosure does not produce jitters in high frequency so as to enhance the test result and the characteristic of the transformer 1. FIG. 7A and FIG. 7B are waveform diagrams illustrating the power spectral density of the transformer of the present disclosure and the conventional transformer. As shown in FIG. 7A, the conventional transformer has a resonance point in the frequency waveform so that the power spectral density of the conventional transformer is enhanced and over the upper limit value. Consequently, the noise is measured easily, and the signal-to-noise ratio of the conventional transformer is increased. Moreover, the transformer 1 of the present disclosure has no resonance point in the frequency waveform so that the power spectral density of the transformer 1 is decreased and lower than the upper limit value. Consequently, the noise is not easy to be measured, and the signal-to-noise ratio of the transformer 1 is decreased.

From above, the first winding 3 and the second winding 4 of the transformer 1 of the present disclosure are twisted with each other to dispose around the middle core part 23. The third winding 5 and the fourth winding 6 are twisted with each other to dispose around the middle core part 23. The windings of the conventional transformer are disposed around the magnetic core directly and arranged in parallel. Compared with the conventional transformer, the windings of the transformer 1 of the present disclosure are disposed around the middle core part 23 tightly. According to the winding structure, the frequency upper limit value of the transformer 1 of the present disclosure is enhanced. Namely, the bandwidth of the transformer 1 of the present disclosure is enhanced. Moreover, the transformer 1 of the present disclosure has no resonance point. The attenuation of the transformer 1 of the present disclosure can reach 14 dB, which is greater than the attenuation of the conventional transformer. The frequency waveform of the transformer 1 is less prone to jitter in the high frequency so as to enhance the characteristic of the transformer 1. The power spectral density of the transformer 1 is decreased to under the upper limit value. Consequently, the noise of the transformer 1 of the present disclosure is not easy to be measured so that the signal-to-noise ratio of the transformer 1 of the present disclosure is decreased.

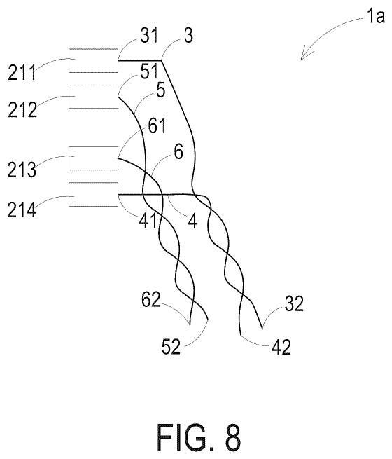

In some embodiments, the winding connection is not limited to the above embodiments and can be adjusted to connect with different electrodes on the first flange 21 and the second flange 22. FIG. 8 is a schematic view illustrating portion of the windings of a transformer according to a second embodiment of the present disclosure. As shown in FIG. 8, in comparison with the transformer 1 of FIG. 2, the third terminal 41 of the second winding 4 of the transformer 1a of this embodiment is disposed on the fourth electrode 214 of the first flange 21. The seventh terminal 61 of the fourth winding 6 of the transformer 1a is disposed on the third electrode 213 of the first flange 21. According to the connection relationship of the windings, the first terminal 31 of the first winding 3, the fifth terminal 51 of the third winding 5, the seventh terminal 61 of the fourth winding 6 and the third terminal 41 of the second winding 4 of the transformer 1a are arranged on the first flange 21 in sequence.

Certainly, the arrangement sequence of the windings disposed on the first flange 21 and the second flange 22 is not limited to the above connection relationships of the windings of the transformer 1 of the first embodiment and the transformer 1a of the second embodiment. For illustrating the possibility of the arrangement sequence of the windings disposed on the first flange 21 and the second flange 22 and simplifying the number of the figures, every possibility of the arrangement sequence of the windings disposed on the first flange 21 and the second flange 22 are shown in the following Table 1. Table 1 shows the terminals of windings of the transformer in different embodiments disposed on the corresponding electrodes of the first flange and the second flange.

TABLE 1

| | Winding | | | | | | | |
|---|---|---|---|---|---|---|---|---|
| | First winding | | Second winding | | Third winding | | Fourth winding | |
| Embodiment | First | Second | Third | Fourth | Fifth | Sixth | Seventh | Eighth |
| number | terminal | terminal | terminal | terminal | terminal | terminal | terminal | terminal |
| 1 | First | Eighth | Third | Sixth | Second | Seventh | Fourth | Fifth |
| | electrode | electrode | electrode | electrode | electrode | electrode | electrode | electrode |
| 2 | First | Eighth | Fourth | Sixth | Second | Seventh | Third | Fifth |
| | electrode | electrode | electrode | electrode | electrode | electrode | electrode | electrode |
| 3 | Second | Eighth | Third | Sixth | First | Seventh | Fourth | Fifth |
| | electrode | electrode | electrode | electrode | electrode | electrode | electrode | electrode |
| 4 | Second | Eighth | Fourth | Sixth | First | Seventh | Third | Fifth |
| | electrode | electrode | electrode | electrode | electrode | electrode | electrode | electrode |
| 5 | First | Eighth | Third | Fifth | Second | Seventh | Fourth | Sixth |
| | electrode | electrode | electrode | electrode | electrode | electrode | electrode | electrode |
| 6 | First | Eighth | Fourth | Fifth | Second | Seventh | Third | Sixth |
| | electrode | electrode | electrode | electrode | electrode | electrode | electrode | electrode |
| 7 | Second | Eighth | Third | Fifth | First | Seventh | Fourth | Sixth |
| | electrode | electrode | electrode | electrode | electrode | electrode | electrode | electrode |
| 8 | Second | Eighth | Fourth | Fifth | First | Seventh | Third | Sixth |
| | electrode | electrode | electrode | electrode | electrode | electrode | electrode | electrode |
| 9 | First | Seventh | Third | Sixth | Second | Eighth | Fourth | Fifth |
| | electrode | electrode | electrode | electrode | electrode | electrode | electrode | electrode |
| 10 | First | Seventh | Fourth | Sixth | Second | Eighth | Third | Fifth |
| | electrode | electrode | electrode | electrode | electrode | electrode | electrode | electrode |
| 11 | Second | Seventh | Third | Sixth | First | Eighth | Fourth | Fifth |
| | electrode | electrode | electrode | electrode | electrode | electrode | electrode | electrode |
| 12 | Second | Seventh | Fourth | Sixth | First | Eighth | Third | Fifth |
| | electrode | electrode | electrode | electrode | electrode | electrode | electrode | electrode |
| 13 | First | Seventh | Third | Fifth | Second | Eighth | Fourth | Sixth |
| | electrode | electrode | electrode | electrode | electrode | electrode | electrode | electrode |
| 14 | First | Seventh | Fourth | Fifth | Second | Eighth | Third | Sixth |
| | electrode | electrode | electrode | electrode | electrode | electrode | electrode | electrode |
| 15 | Second | Seventh | Third | Fifth | First | Eighth | Fourth | Sixth |
| | electrode | electrode | electrode | electrode | electrode | electrode | electrode | electrode |
| 16 | Second | Seventh | Fourth | Fifth | First | Eighth | Third | Sixth |
| | electrode | electrode | electrode | electrode | electrode | electrode | electrode | electrode |

For example, as shown in the transformer of the embodiment number 4 of Table 1, the first terminal 31 of the first winding 3 is disposed on the second electrode 212 of the first flange 21, the second terminal 32 of the first winding 3 is disposed on the eighth electrode 224 of the second flange 22, the third terminal 41 of the second winding 4 is disposed on the fourth electrode 214 of the first flange 21, the fourth terminal 42 of the second winding 4 is disposed on the sixth electrode 222 of the second flange 2, the fifth terminal 51 of the third winding 5 is disposed on the first electrode 211 of the first flange 21, the sixth terminal 52 of the third winding 5 is disposed on the seventh electrode 223 of the second flange 22, the seventh terminal 61 of the fourth winding 6 is disposed on the third electrode 213 of the first flange 21, and the eighth terminal 62 of the fourth winding 6 is disposed on the fifth electrode 221 of the second flange 22. According to the connection relationship of the windings, in the transformer 1 of this embodiment, the fifth terminal 51 of the third winding 5, the first terminal 31 of the first winding 3, the seventh terminal 61 of the fourth winding 6 and the third terminal 41 of the second winding 4 are arranged on the first flange 21 in sequence. The second terminal 32 of the first winding 3, the sixth terminal 52 of the third winding 5, the fourth terminal 42 of the second winding 4 and the eighth terminal 62 of the fourth winding 6 are arranged on the second flange 22 in sequence. For simplifying the illustration, the connection relationships of the windings of the transformers in different embodiments are not redundantly described hereinafter.

According to Table 1, as the transformers numbered 1, 5, 9 and 13, the first terminal 31 of the first winding 3, the fifth terminal 51 of the third winding 5, the third terminal 41 of the second winding 4 and the seventh terminal 61 of the fourth winding 6 are arranged on the first flange 21 in sequence. As the transformers numbered 2, 6, 10 and 14, the first terminal 31 of the first winding 3, the fifth terminal 51 of the third winding 5, the seventh terminal 61 of the fourth winding 6 and the third terminal 41 of the second winding 4 are arranged on the first flange 21 in sequence. As the transformers numbered 3, 7, 11 and 15, the fifth terminal 51 of the third winding 5, the first terminal 31 of the first winding 3, the third terminal 41 of the second winding 4 and the seventh terminal 61 of the fourth winding 6 are arranged on the first flange 21 in sequence. As the transformers numbered 4, 8, 12 and 16, the fifth terminal 51 of the third winding 5, the first terminal 31 of the first winding 3, the seventh terminal 61 of the fourth winding 6 and the third terminal 41 of the second winding 4 are arranged on the first flange 21 in sequence.

As the transformers numbered 1, 2, 3 and 4, the second terminal 32 of the first winding 3, the sixth terminal 52 of the third winding 5, the fourth terminal 42 of the second winding 4 and the eighth terminal 62 of the fourth winding 6 are arranged on the second flange 22 in sequence. As the transformers numbered 5, 6, 7 and 8, the second terminal 32 of the first winding 3, the sixth terminal 52 of the third winding 5, the eighth terminal 62 of the fourth winding 6 and the fourth terminal 42 of the second winding 4 are arranged on the second flange 22 in sequence. As the transformers numbered 9, 10, 11 and 12, the sixth terminal 52 of the third winding 5, the second terminal 32 of the first winding 3, the fourth terminal 42 of the second winding 4 and the eighth terminal 62 of the fourth winding 6 are arranged on the second flange 22 in sequence. As the transformers numbered 13, 14, 15 and 16, the sixth terminal 52 of the third winding 5, the second terminal 32 of the first winding 3, the eighth terminal 62 of the fourth winding 6 and the fourth terminal 42 of the second winding 4 are arranged on the second flange 22 in sequence. The frequency upper limit value of the transformer of the present disclosure is enhanced according to the arrangement sequence of windings disposed on the first flange 21 and the second flange 22.

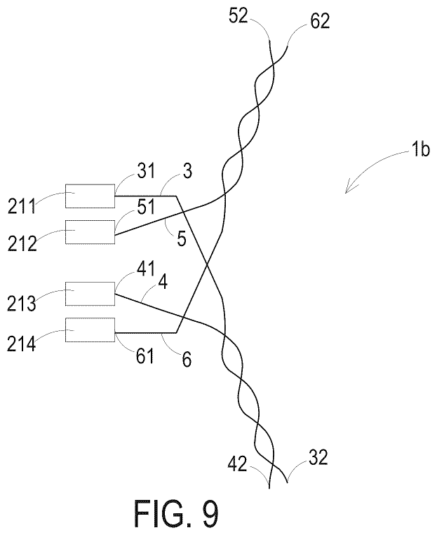

In some embodiments, the winding directions of the first winding 3 and the second winding 4 disposed around the middle core part 23 are opposite to the winding directions of the third winding 5 and the fourth winding 6 disposed around the middle core part 23. FIG. 9 is a schematic view illustrating portion of the windings of a transformer according to a third embodiment of the present disclosure. As shown in FIG. 9, in comparison with the transformer 1 of FIG. 2, the winding directions of the first winding 3 and the second winding 4 of the transformer 1b of this embodiment disposed around the middle core part 23 are defined as first directions, and the winding directions of the third winding 5 and the fourth winding 6 of the transformer 1b disposed around the middle core part 23 are defined as second directions. The second direction is opposite to the first direction. For example, the first direction is the clockwise direction, and the second direction is the counterclockwise direction. The frequency upper limit value of the transformer 1b of this embodiment is enhanced according to the difference between the winding directions of the two winding assemblies, one of the two winding assemblies is the combination of the first winding and the second winding, the other one of the two winding assemblies is the combination of the third winding and the fourth winding.

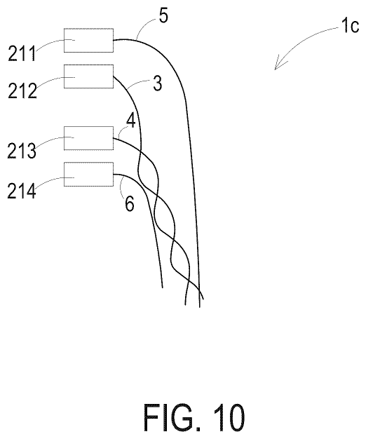

In some embodiments, two of the four windings are twisted with each other to dispose around the middle core part, and the other two of the four windings are not twisted with each other to dispose around the middle core part. Namely, two of the four windings are twisted with each other to dispose around the middle core part, and the other two of the four windings are disposed around the middle core part in parallel. FIG. 10 is a schematic view illustrating portion of the windings of a transformer according to a fourth embodiment of the present disclosure. As shown in FIG. 10, in comparison with the transformer 1 of FIG. 2, the first winding 3 and the second winding 4 of the transformer 1c of this embodiment are twisted with each other to dispose around the middle core part 23 and form an outer layer. The third winding 5 and the fourth winding 6 are disposed around the middle core part 23 in parallel to form an inner layer. Similar to the structure shown in FIG. 3, the inner layer formed by the third winding 5 and the fourth winding 6 is located between the middle core part 23 and the outer layer formed by the first winding 3 and the fourth winding 4.

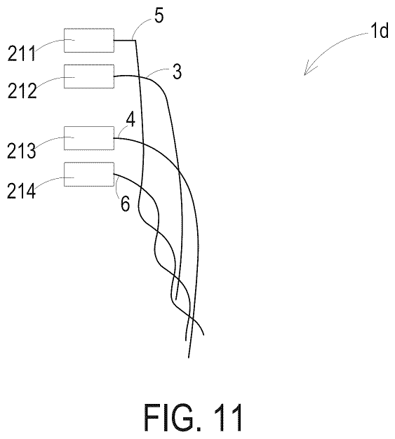

FIG. 11 is a schematic view illustrating portion of the windings of a transformer according to a fifth embodiment of the present disclosure. As shown in FIG. 11, in comparison with the transformer 1 of FIG. 2, the first winding 3 and the second winding 4 of the transformer 1d of this embodiment are disposed around the middle core part 23 in parallel to form an outer layer. The third winding 5 and the fourth winding 6 are twisted with each other to dispose around the middle core part 23 and form an inner layer. Similar to the structure shown in FIG. 3, the inner layer formed by the third winding 5 and the fourth winding 6 is located between the middle core part 23 and the outer layer formed by the first winding 3 and the fourth winding 4.

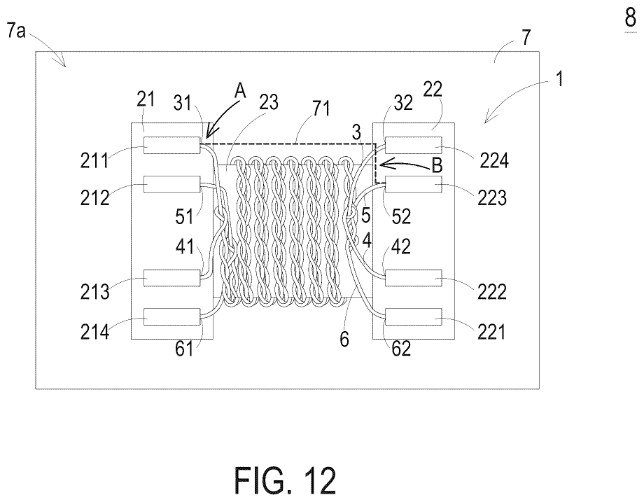

FIG. 12 is a schematic view illustrating a transformer system according to a first embodiment of the present disclosure. As shown in FIG. 12, the transformer system 8 of this embodiment includes the transformer 1 of the first embodiment and a circuit board 7. It is noted that the structure of the transformer is not limited to the first embodiment. Alternatively, the transformer with the structure shown in other embodiment can be used in the transformer system 8. The circuit board 7 includes a surface 7a. The transformer 1 is disposed on the surface 7a of the circuit board 7. The surface 7a of the circuit board 7 has a wire 71, as shown the dotted line in FIG. 12. Two ends of the wire 71 are connected with the first winding 3 and the third winding 5, respectively. The extension direction of the wire 71 is the same with the extension direction of the middle core part 23. The projection of the wire 71 on the surface 7a of the circuit board 7 is partially overlapped with the projection of the first flange 21 on the surface 7a of the circuit board 7 and the projection of the second flange 22 on the surface 7a of the circuit board 7 (see the arrow A and B of FIG. 12). The noise of the transformer 1 of the present disclosure is decreased according to the relative position between the wire 71 and the transformer 1.

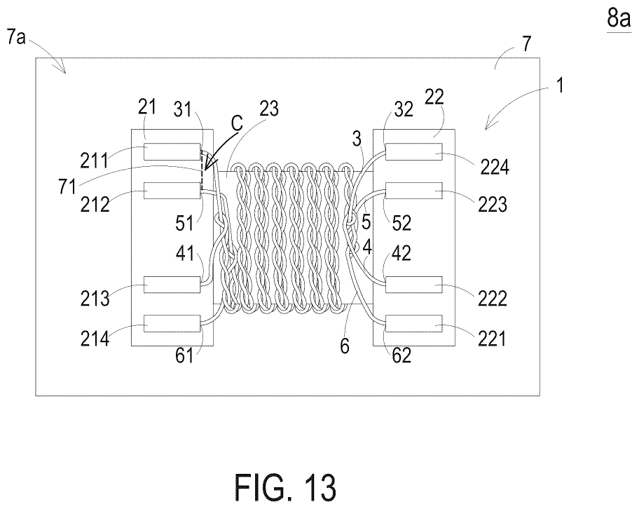

FIG. 13 is a schematic view illustrating a transformer system according to a second embodiment of the present disclosure. As shown in FIG. 13, the transformer system 8a includes the transformer 1 of the first embodiment and a circuit board 7. It is noted that the structure of the transformer is not limited to the first embodiment. Alternatively, the transformer with the structure shown in other embodiment can be used in the transformer system 8a. The transformer 1 is disposed on the surface 7a of the circuit board 7. The surface 7a of the circuit board 7 has a wire 71, as shown the dotted line in FIG. 13. Two ends of the wire 71 are connected with the first winding 3 and the third winding 5, respectively. The extension direction of the wire 71 is different to the extension direction of the middle core part 23. For example, the extension direction of the wire 71 is perpendicular to the extension direction of the middle core part 23. The projection of the wire 71 on the surface 7a of the circuit board 7 is partially overlapped with the projection of the first flange 21 on the surface 7a of the circuit board 7 (see the arrow C of FIG. 13). The current loss of the transformer 1 of the present disclosure is decreased according to the relative position between the wire 71 and the transformer 1. Certainly, in some embodiments, the projection of the wire 71 on the surface 7a of the circuit board 7 is partially overlapped with the projection of the second flange 22 on the surface 7a of the circuit board 7.

From above descriptions, the first winding and the second winding of the transformer of the present disclosure are twisted with each other to dispose around the middle core part. The third winding and the fourth winding are twisted with each other to dispose around the middle core part, or the third winding and the fourth winding are disposed around the middle core part in parallel. The windings of the transformer of the present disclosure are disposed around the middle core part tightly. According to the winding structure, the frequency upper limit value of the transformer of the present disclosure is enhanced. Namely, the bandwidth of the transformer of the present disclosure is enhanced. Moreover, the transformer of the present disclosure has no resonance point. The attenuation of the transformer of the present disclosure can reach 14 dB, which is greater than the attenuation of the conventional transformer. The frequency waveform of the transformer is less prone to jitter in the high frequency so as to enhance the characteristic of the transformer. The power spectral density of the transformer is decreased to under the upper limit value. Consequently, the noise of the transformer of the present disclosure is not easy to be measured so that the signal-to-noise ratio of the transformer is decreased.

While the disclosure has been described in terms of what is presently considered to be the most practical and preferred embodiments, it is to be understood that the disclosure needs not be limit value to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A transformer, comprising:
a magnetic core comprising a first flange, a second flange and a middle core part, wherein the middle core part is located between the first flange and the second flange;
a first winding comprising a first terminal and a second terminal, wherein the first terminal is disposed on the first flange, the second terminal is disposed on the second flange, and the first winding is disposed around the middle core part;
a second winding comprising a third terminal and a fourth terminal, wherein the third terminal is disposed on the first flange, the fourth terminal is disposed on the second flange, and the second winding is disposed around the middle core part;
a third winding comprising a fifth terminal and a sixth terminal, wherein the fifth terminal is disposed on the first flange, the sixth terminal is disposed on the second flange, and the third winding is disposed around the middle core part; and
a fourth winding comprising a seventh terminal and an eighth terminal, wherein the seventh terminal is disposed on the first flange, the eighth terminal is disposed on the second flange, and the fourth winding is disposed around the middle core part;
wherein the first winding and the second winding are twisted with each other to form a first twist winding, the first twist winding is disposed around the middle core part, the third winding and the fourth winding are twisted with each other to form a second twist winding, the second twist winding is disposed around the middle core part, and the first twist winding and the second twist winding are not twisted with each other.

2. The transformer according to claim 1, wherein the first winding and the third winding are served as a primary winding of the transformer, and the second winding and the fourth winding are served as a secondary winding of the transformer.

3. The transformer according to claim 1, wherein the first terminal of the first winding, the fifth terminal of the third winding, the third terminal of the second winding and the seventh terminal of the fourth winding are arranged on the first flange in sequence.

4. The transformer according to claim 1, wherein the fifth terminal of the third winding, the first terminal of the first winding, the third terminal of the second winding and the seventh terminal of the fourth winding are arranged on the first flange in sequence.

5. The transformer according to claim 1, wherein the first terminal of the first winding, the fifth terminal of the third winding, the seventh terminal of the fourth winding and the third terminal of the second winding are arranged on the first flange in sequence.

6. The transformer according to claim 1, wherein the fifth terminal of the third winding, the first terminal of the first winding, the seventh terminal of the fourth winding and the third terminal of the second winding are arranged on the first flange in sequence.

7. The transformer according to claim 1, wherein winding directions of the first winding and the second winding disposed around the middle core part are the same with winding directions of the third winding and the fourth winding disposed around the middle core part.

8. The transformer according to claim 1, wherein winding directions of the first winding and the second winding disposed around the middle core part are opposite to winding directions of the third winding and the fourth winding disposed around the middle core part.

9. The transformer according to claim 1, wherein the second terminal of the first winding, the sixth terminal of the third winding, the fourth terminal of the second winding and the eighth terminal of the fourth winding are arranged on the second flange in sequence.

10. The transformer according to claim 1, wherein the sixth terminal of the third winding, the second terminal of the first winding, the fourth terminal of the second winding and the eighth terminal of the fourth winding are arranged on the second flange in sequence.

11. The transformer according to claim 1, wherein the second terminal of the first winding, the sixth terminal of the third winding, the eighth terminal of the fourth winding and the fourth terminal of the second winding are arranged on the second flange in sequence.

12. The transformer according to claim 1, wherein the sixth terminal of the third winding, the second terminal of the first winding, the eighth terminal of the fourth winding and the fourth terminal of the second winding are arranged on the second flange in sequence.

13. A transformer, comprising:
a magnetic core comprising a first flange, a second flange and a middle core part, wherein the middle core part is located between the first flange and the second flange;
a first winding comprising a first terminal and a second terminal, wherein the first terminal is disposed on the first flange, the second terminal is disposed on the second flange, and the first winding is disposed around the middle core part;
a second winding comprising a third terminal and a fourth terminal, wherein the third terminal is disposed on the first flange, the fourth terminal is disposed on the second flange, and the second winding is disposed around the middle core part;
a third winding comprising a fifth terminal and a sixth terminal, wherein the fifth terminal is disposed on the first flange, the sixth terminal is disposed on the second flange, and the third winding is disposed around the middle core part; and
a fourth winding comprising a seventh terminal and an eighth terminal, wherein the seventh terminal is disposed on the first flange, the eighth terminal is disposed on the second flange, and the fourth winding is disposed around the middle core part;
wherein the first winding and the second winding are twisted with each other to dispose around the middle core part, and the third winding and the fourth winding are disposed around the middle core part in parallel.

14. A transformer system, comprising:
a transformer, comprising:
a magnetic core comprising a first flange, a second flange and a middle core part, wherein the middle core part is located between the first flange and the second flange;
a first winding comprising a first terminal and a second terminal, wherein the first terminal is disposed on the first flange, the second terminal is disposed on the second flange, and the first winding is disposed around the middle core part;
a second winding comprising a third terminal and a fourth terminal, wherein the third terminal is disposed on the first flange, the fourth terminal is disposed on the second flange, and the second winding is disposed around the middle core part;
a third winding comprising a fifth terminal and a sixth terminal, wherein the fifth terminal is disposed on the first flange, the sixth terminal is disposed on the second flange, and the third winding is disposed around the middle core part; and
a fourth winding comprising a seventh terminal and an eighth terminal, wherein the seventh terminal is disposed on the first flange, the eighth terminal is disposed on the second flange, and the fourth winding is disposed around the middle core part;
wherein the first winding and the second winding are twisted with each other to dispose around the middle core part, wherein the third winding and the fourth winding are twisted with each other to dispose around the middle core part, or the third winding and the fourth winding are disposed around the middle core part in parallel; and
a circuit board, wherein the transformer is disposed on the circuit board, the circuit board has a wire, and two ends of the wire are electrically connected with the first winding and the third winding.

15. The transformer system according to claim 14, wherein a first extension direction of the wire is the same with a second extension direction of the middle core part.

16. The transformer system according to claim 14, wherein a first projection of the wire on a surface of the circuit board is partially overlapped with a second projection of the first flange on the surface of the circuit board and a third projection of the second flange on the surface of the circuit board.

17. The transformer system according to claim 14, wherein a first extension direction of the wire is different to a second extension direction of the middle core part.

18. The transformer system according to claim 14, wherein a first projection of the wire on a surface of the circuit board is partially overlapped with a second projection of the first flange on the surface of the circuit board or a third projection of the second flange on the surface of the circuit board.

19. The transformer system according to claim 14, wherein the first winding and the second winding are twisted with each other to form a first twist winding, the first twist winding is disposed around the middle core part, the third winding and the fourth winding are twisted with each other to form a second twist winding, the second twist winding is disposed around the middle core part, and the first twist winding and the second twist winding are not twisted with each other.
